(19) United States
(12) Patent Application Publication
(10) Pub. No.: US 2015/0040920 A1
(43) Pub. Date: Feb. 12, 2015

(54) Non-woven body for binding mercury

(71) Applicant: Stephan Spanner, Munchen (DE)

(72) Inventor: Stephan Spanner, Munchen (DE)

(21) Appl. No.: 14/357,808

(22) PCT Filed: Oct. 16, 2012
(86) PCT No.: PCT/DE2012/001007

§ 371 Date: May 13, 2014

(30) Foreign Application Priority Data
Nov. 17, 2011 (DE) 102011118751.4

(51) Int. Cl. B01J 20/02; B01J 20/20; A41D 13/11; B01J 20/30; B01D 53/02; B01J 20/28; B01J 20/32

(52) U.S. Cl. CPC B01J 20/02; B01J 20/28035; B01J 20/205; B01J 20/3202; B01J 20/3214; B01J 20/3236; B01J 20/3007; B01J 20/3078; B01D 53/02; A41D 13/11; B01D 2257/602; B01D 2259/4533; B01D 2259/4541; B01D 2253/1122; B01D 2253/102
USPC 128/863; 442/379

(57) ABSTRACT

A non-woven body for binding mercury, comprising a substrate made from a nonwoven fabric, wherein the body is doped with gold on the outside and with silver on the inside, is characterized in that the substrate comprises an outer ply that encloses the outside, an inner play that encloses the inside, and an electrically neutral intermediate ply is interposed between the outer ply and the inner ply. Such a non-woven body may be used as a protective mask of also as lining for a box for disposal of broken energy-saving lamps.

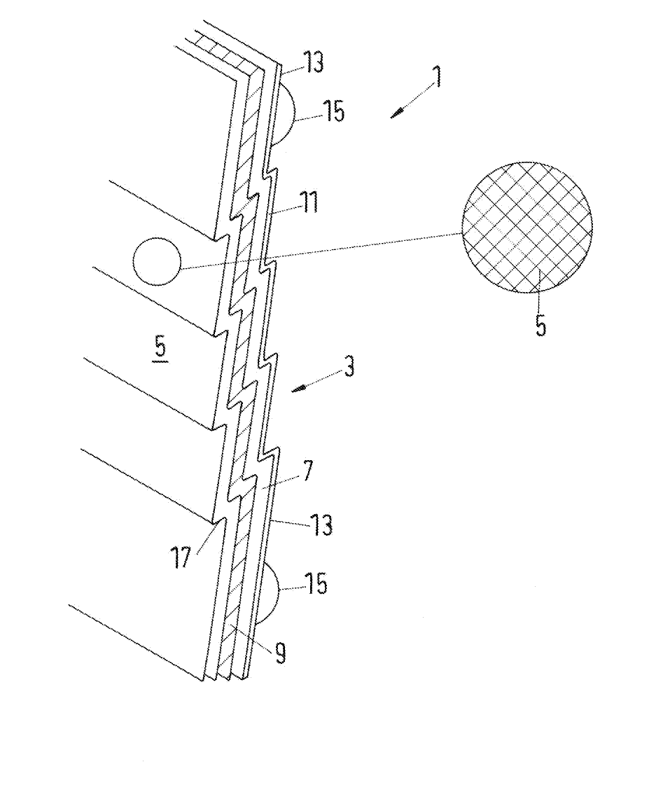

The present invention relates to a non-woven body for binding mercury, comprising a base body made from a nonwoven fabric, wherein the body is doped with gold on the outside and with silver on the inside.

Such non-woven bodies are known in the prior art. Protective masks equipped with such non-woven bodies have been in regular use in dentists' surgeries to trap mercury for about ten years, for example, Aerosols containing mercury are produced whenever amalgam fillings are drilled, milled, ground or polished, and it is important that the staff in the dental practice do not breathe these in, But mercury fumes in concentrations as high as 300 μg/m³ to 3000 μg/m³ are also produced close to the patient's mouth when amalgam fillings are being implanted or removed. Without a protective mask for binding mercury, the dentist and dental assistant as well as the patient breathe these fumes in. The World Health Organization has fixed the permissible upper limit for these concentrations at 50 μg/m³.

Similar problems are encountered by those working with mercury-containing energy-saving light bulbs. Up to 20% of the lamps delivered break during transit, so that business premises, trucks, recycling centres and recycling plants are exposed to a significant mercury contamination. Conventional protective masks cannot adequately filter the mercury fumes.

The upstream side of the protective masks for binding mercury, that is to say the outside thereof, is coated with gold, which binds the mercury immediately in the form of gold amalgam. The use of surgical masks with a gold deposition coating helps to protect both doctors and patients from the dangers of mercury contamination. There are differences in the design of the mask. For example, the medical staff wears full face masks that are worn over the nose and mouth, while patients wear specially sewn partial masks that extend from the bridge of the nose to the upper lip.

Besides the gold doping on the outside, the protective masks according to the prior art are coated with silver on the inside. Because of its bactericidal properties, silver protects against bacterial attack. The silver layer is applied to the back of a gold coated substrate. The substrate is typically a polypropylene fleece with contoured calendering having a weight of 25 g/m² to 50 g/m². In all, the protective mask consists of three non-woven plies, wherein the two plies closest to the face have undergone little or no contoured calendering. The protective mask is produced with pleats and provided with a sewn or welded nosepiece. During use, the nosepiece is placed over the bridge of the nose, and the mouth protection is tightened under the chin. This ensures that the mask tightly covers the mouth and nose as the breathing organs.

The disadvantage of such protective masks of the prior art consists in that the gold on the outer surface is distributed unevenly, and dielectric effects occur between the gold layer and the silver layer.

Therefore, the object of the present invention is to improve a non-woven body of the kind described in the introduction such that no dielectric effects occur between the gold layer and the silver layer.

The object is solved according to the invention in that the substrate comprises a first nonwoven ply that encloses the outside, and a second non-woven ply that encloses the inside, and an electrically neutral intermediate non-woven ply is interposed between the first and second non-woven plies.

The arrangement of the electrically neutral non-woven intermediate layer prevents dielectric effects from taking place between the gold on the outside and the silver on the inside. These are more likely to occur without the intermediate fleece ply because calendaring creates seams in which gold accumulates in greater quantities on the outside and silver accumulates in greater quantities on the inside. The intermediate fleece ply ensures that a distance is maintained between the gold and the silver. Consequently, the trapping efficiency of the protective mask can be improved significantly, and is preferably between 98% and 100%.

A further advantage of the present invention is that the outer surface thereof is seamless. It is possible to form the first non-woven ply as a smoothly calendered non-woven ply. The avoidance of seams on the outside means that less gold is used. The gold is distributed on the outside more evenly.

A further advantage of the present invention is that the intermediate non-woven ply is doped with carbon nanotubes.

Doping of the intermediate non-woven ply with carbon nanotubes results in the advantage that when the surface of the first nonwoven ply is saturated and the trapping efficiency is diminished, a reference back, a hold point at a trapping efficiency of 80% and a decrease in overall trapping efficiency to zero is delayed. Evidently, the binding function is divided between the filtering gold surface and the carbon nanotubes below a trapping efficiency of about 80%, thereby delaying the mercury saturation point.

A further advantage of the present invention is that the inside has a flexible peripheral seam. Due to the flexible peripheral flange, the risk of leaked air being drawn into ill-fitting masks is reduced.

A further advantage of the present invention is that the peripheral seam is latex-free. Many wearers of protective masks are allergic to latex.

A further advantage of the present invention is that the second non-woven ply has an inner layer of a dermatologically compatible material, which forms the inside. In this way, irritation can be prevented.

Further advantages of the present invention will become apparent from the features of the subordinate claims.

An embodiment of the present invention is described in greater detail in the following with reference to the drawing. The single FIGURE shows a schematic representation of a cross section through a protective mask according to the present invention.

In the FIGURE, a part of a non-woven body 1 is shown schematically. Non-woven body 1 has a substrate 3. Substrate 3 is made from a non-woven material and comprises an outer ply 5, an inner ply 7 and an intermediate ply 9. When non-woven body 1 is worn as a protective mask, for example, outer ply 5 is also the outer side or the upstream side of the contaminated ambient air, while inner ply 7 is closest to the wearer's face when the mask is being worn.

Gold is applied evenly to outer ply 5. The gold is preferably applied to outer ply 5 by vapour deposition. Outer ply 5 is seamless in the present embodiment. Non-woven body 1 is produced for example by smooth calendaring or thermobonding, to impart the necessary strength to outer ply 5, inner ply 7 and also intermediate ply 9.

Silver is applied evenly to inner ply 7 is applied uniformly. The silver is preferably is preferably applied to inner ply 7 by vapour deposition. Inner ply 7 is seamless in the present embodiment. Production is carried out by smooth calendering or thermobonding, to impart the necessary strength to inner ply 7.

Electrically neutral intermediate ply 9 is disposed between outer ply 5 and inner ply 7. This intermediate ply 9 insulates outer ply 5 and inner ply 7 from each other so that no dielectric effects occur even if seams are created in outer ply 5 and inner ply 7. In one embodiment, intermediate ply 9 also comprises carbon nanotubes (not shown). The intermediate ply 9 is then preferably prepared in a melt-blown process.

In the FIGURE, the smoothness of outer ply 5 is shown in an enlarged view. For use as a protective mask, non-woven body 1 is pleated. In other embodiments, the pleats may be omitted.

In the embodiment as a protective mask , non-woven body 1 has an inner layer 11 that is applied to the inside of inner ply 7 and consists of a dermatologically compatible material so as to avoid skin irritation. In addition, inner ply 7 has a peripheral seam 15 that is latex-free at one edge 13, to ensure airtight contact with a face, and to prevent the ingress of leaked air. Non-woven body 1 as a protective mask is dimensioned in such manner that in one embodiment for patients it extends from the bridge of the nose to the upper lip, wherein pleats 17 allow adaptation to individual body measurements. In an embodiment for medical or healthcare personnel, woven body 1 is dimensioned such that the mask extends from the bridge of the nose and covers the mouth as well. Here too, pleats 17 are intended to allow adaptation to individual body measurements.

In a further embodiment, non-woven body 1 can also be used to cover energy-saving lamps, which contain mercury, when they are broken or for cleaning mercury-containing surfaces. In one embodiment, non-woven body 1 is an inner panel for a box (not shown) made from cardboard or some other material.

For cleaning surfaces that are contaminated with mercury, gold nanoparticles are added to a commercially available shampoo or other detergent in liquid form, and this is then applied to said contaminated surfaces. The surface is then wiped off with a damp cloth and rubbed dry with a gold-coated cloth. Both the washing water and the towels collected in a gas-tight container and recycled.

### LIST OF REFERENCE SIGNS

1 Non-woven body
3 Substrate
5 Outer ply
7 Inner ply
9 Intermediate ply
11 Inner layer
13 Edge
15 Peripheral seam
17 Pleats

1. A non-woven body for binding mercury, having a substrate made from a non-woven fabric, wherein the substrate is doped with gold on the outside and with silver on the inside,
comprising:
the substrate (3) comprises an outer ply (5) that encloses the outside and an inner ply (7) that encloses the inside, wherein an electrically neutral intermediate ply (9) is arranged between outer ply (5) and inner ply (7).

2. A non-woven body according to claim 1,
wherein
the outer ply (5) is seamless.

3. A non-woven body according to claim 1,
wherein
the intermediate ply (9) is doped with carbon nanotubes.

4. A non-woven body according to any of claim 1,
wherein
the substrate (3) forms a protective mask and the inner ply (7) has a flexible peripheral seam (15).

5. A non-woven body according to claim 4,
wherein
the peripheral seam (15) is latex-free.

6. A non-woven body according to claim 1,
wherein
inner ply (7) has an inner layer (17) made from a dermatologically compatible material that forms the inside.

7. A non-woven body according to claim 4,
wherein
the substrate (3) has a contour that covers a facial area between the bridge of the nose and the upper lip when worn as a mask.

8. A non-woven body according to claim 1,
wherein
outer ply (5) is coated with gold by vapour deposition.

9. A non-woven body according to claim 1,
wherein
the outer ply (5) and the inner ply (7) are calendered seamlessly.

10. A non-woven body according to claim 1,
wherein
the substrate (3) is strengthened by thermobonding.

11. A non-woven body according to claim 1,
wherein
the substrate (3) is prepared in a melt-blown process.
